(19) United States
(12) Patent Application Publication
(10) Pub. No.: US 2005/0120072 A1
(43) Pub. Date: Jun. 2, 2005

(54) Company-to-company data cooperation system

(76) Inventors: Yukihisa Miyazaki, Kikuchi-gun (JP); Akira Hamasaki, Itami-shi (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/500,326

(22) PCT Filed: Jan. 15, 2003
(86) PCT No.: PCT/JP03/00235

(51) Int. Cl. G06F 15/16

(52) U.S. Cl. 709/201; 709/206

(57) ABSTRACT

A data exchange system among in which data is mutually exchanged among cooperative companies which produce products cooperatively, provides for periodically collecting or retrieving at least one of product progress information, quality information, and business information of one's own company, standardizing and editing data for transmission to the cooperative companies, exchanging data between one's own company and the other companies, outputting transmission data to a file in a fixed format as attached data of an e-mail, automatically and periodically transmitting the e-mail to the cooperative companies, and receiving e-mail corresponding to the transmission data from the cooperative companies.

### TECHNICAL FIELD

The present invention relates to a data exchange system among cooperative companies, in which a plurality of domestic and international different companies partially take charge of a series of manufacturing steps of a product to be manufactured and manufacturing data regarding the product is mutually transmitted and received surely and effectively among the companies in cooperative production.

### BACKGROUND ART

Conventionally, since semiconductor manufacturing companies each build up their own production management systems so that their O/S, software and database are different from each other, it is difficult that the series of semiconductor manufacturing steps are shared by a plurality of companies in various reasons. However, conventionally, the series of semiconductor manufacturing steps have been shared by ordering to outside factories. In this case, in fact, the production management system is mainly organized by a parent company and the outside factory is forced to follow the production management system of the parent company. In addition, with regard to production management information also, the outside factory only receives it through LAN connection to the parent system.

According to a recent foundry production system (cooperative production system by a plurality of cooperative companies), a merit in bidirectional and rational system is demanded in the conventional method of transmitting and receiving the production management information, and it is found that a production management cost is substantially increased and a profit is not turned when a system where the ordered side is compelled to follow is employed. In addition, according to the conventional sharing of manufacturing steps and manufacturing management system in a company group, data is collected from the outside factory to the parent company in one direction and the information is taken in the database in the parent company and initiatively used by the parent company. This system initiated by the parent company is carried out also when the company has an international base as well as domestic base.

Meanwhile, there is a method in which data is provided on the Web unilaterally, and a person in charge of using the data accesses that data and downloads and takes it in his own database to use it, if necessary. For example, Japanese Unexamined Patent Publication No. 2001-312536 discloses a method in which most recent information from an information provider is disclosed on the Web and the updated information is sent to a specific person in charge by attaching it to e-mail if required.

FIG. 11 shows a whole view of the above-described system. The production management system shown in FIG. 11 is designed such that it is connected to an overseas ODM company through the internet, and a product is sent from the ODM company to a distributor and from the distributor to a customer so that it arrives at a customer at an appropriate time without involving the ODM company.

For example, in a case where an ordering company D orders a company W which is in charge of wafer manufacturing steps and a company A which is in charge of assembling steps, to manufacture a product P, it is necessary to exchange information such as daily in-process information, progress information, yield information and quality information between the company W and the company A in a certain cycle. In addition, it is necessary for the company A which is in charge of the assembling steps to provide information such as quality information, final test data and defective category information every time each assembling step is completed to the company W which is in charge of the wafer manufacturing steps, and also it is necessary for the company W and the company A to sent the completion information to the ordering company D in a certain cycle. The present invention is not limited to the above three companies such as D, W and A, and it is an object of the present invention to enable data to be exchanged effectively and inexpensively over a plurality of companies in two-way direction.

According to the conventional technique, that is, Japanese Unexamined Patent Publication No. 2001-312536, for example, the overseas ODM company has to connect to the internet and download desired information on the Web.

This method of disclosing the information is described hereinafter. For example, when the above company D, W and A each disclose information on the Web, the company D updates data on its own website and sends a fact that the information is updated and URL for accessing the updated information to the companies W and A by e-mail. The companies W and A access the website from the informed URL. Similarly, the companies W and A also update data on their own websites and send the updated information to the other companies.

The person in charge who received the mail has to manually access the website through the informed URL from a terminal which can be connected to the internet. In order to download it in its own database, the person in charge has to manually input the data while referring to the website. Therefore, a lot of labor is needed.

In addition, when a certain company takes a long vacation or the person in charge is absent, the progress information or the shipment information of the product cannot be obtained or the data is not updated sometimes. Accordingly, the data of one's own could not be updated.

### DISCLOSURE OF INVENTION

According to the present invention, in order to solve the above problems, information items are standardized among companies in which information is exchanged, and information item to be transmitted or received is extracted and determined. In addition, when the description of the common information used among the companies are different, the common information items are specified as identifiers and a corresponding table for the identifiers used in each company is defined. Furthermore, a collecting cycle and an updating cycle of the information is decided using the identifier as a keyword, and the information is transmitted or received among the companies to each other.

In general, lot numbers and product type names cannot be commonly used because they are standardized for convenience of the manufacturing system in each company. The cooperative companies cannot decide to which system the information of the product to be manufactured is downloaded from the product type names or lot numbers in a contracted company. Therefore, it is necessary to convert them to the lot numbers and the product type names for each cooperative company.

At this time, the items can be easily converted to those for each company by providing a conversion master even when the plurality of companies partially take charge of the manufacturing steps. In addition, even when a new contract is completed with a new company, the new company can be easily adapted by adding its items to the conversion master.

Thus, the burden for a person in charge of developing the system is reduced and development period is shortened.

Standardization of the information items comprises a reception information item table for use in a specific company to receive the information and a transmission information item table for use in the company to transmit the information.

The data exchange system among cooperative companies of the present invention exchanges data mutually among the plurality of cooperative companies handling cooperative production, which periodically collects or retrieves at least one of product progress information, quality information and business information of one's own company, standardizes and edits data for transmission to the cooperative companies, exchanges data between one's own company and the other company, outputs transmission data file in a predetermined format as an attached data of e-mail, automatically and periodically transmits the e-mail to the cooperative companies, and receives e-mail corresponding to the above from the cooperative companies.

### BRIEF DESCRIPTION OF DRAWINGS

FIG. 1 is a view showing a system constitution in a case of transmission according to an embodiment 1 of the present invention.

FIG. 2 is a view showing a system constitution in a case of reception according to the embodiment 1 of the present invention.

FIG. 3 is a view showing a system constitution in a case of transmission according to an embodiment 2 the present invention.

FIG. 4 is a view showing a system constitution in a case of reception according to the embodiment 2 of the present invention.

FIG. 5 is a view showing a production management system according to the embodiments 1 and 2 of the present invention.

FIG. 6 is a view showing a business management system according to the embodiments 1 and 2 of the present invention.

FIG. 7 is a view showing a quality management system according to the embodiments 1 and 2 of the present invention.

FIG. 8 is a view showing a conversion table (an example of a conversion master).

FIG. 9 is a view showing a display image (table) of a test result on the intranet.

FIG. 10 is a view showing a display image (graph) of a test result on the intranet.

FIG. 11 is a view showing an example of a conventional production management system.

### BEST MODE FOR CARRYING OUT THE INVENTION

According to a data exchange system among cooperative companies of the present invention, a conventional function of a data exchange system for a subcontracting company is extended such that each cooperative company may have more even function to enable bidirectional data exchange, and enable the data required for cooperation to be automatically and directly transmitted only to the company which needs the data, in a desired cycle without manual operation. In addition, since a common information web is not used and the data is directly transmitted to the company which needs the information, a security problem among the plurality of cooperative companies can be relieved.

Therefore, according to the present invention, the data exchange system among cooperative companies comprises a mailing system in which production progress information and quality information are standardized and collected in a predetermined cycle in each company of different cooperative companies and automatically and mutually transmitted to the cooperative companies with a file in CSV format, for example, attached to e-mail by a scheduling function of a data exchange server, a production management system, a business management system, and a web system. As a result, a progress condition, a dispatch condition and quality information of the products can be mutually confirmed in each predetermined cycle among cooperative companies.

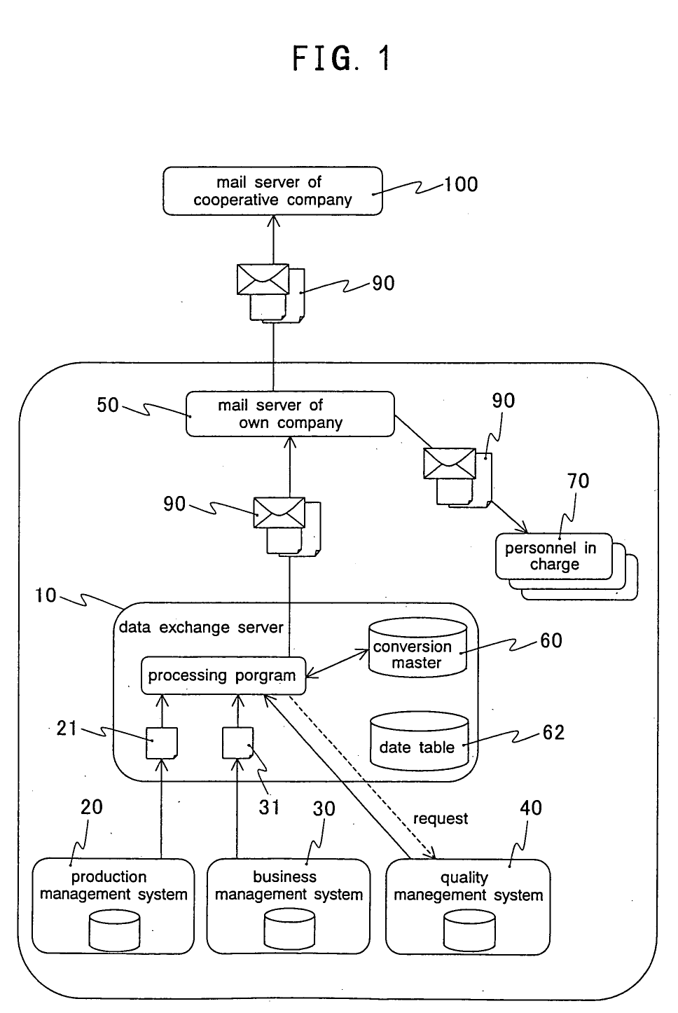

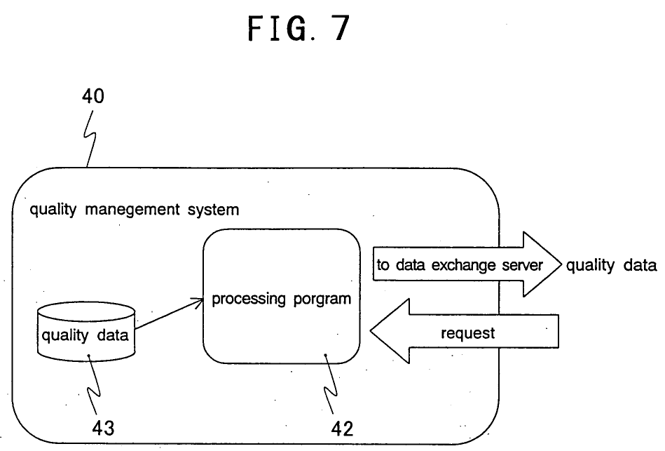

Hereinafter, embodiments of the present invention are described with reference to FIGS. 1 to 10.

### EMBODIMENT 1

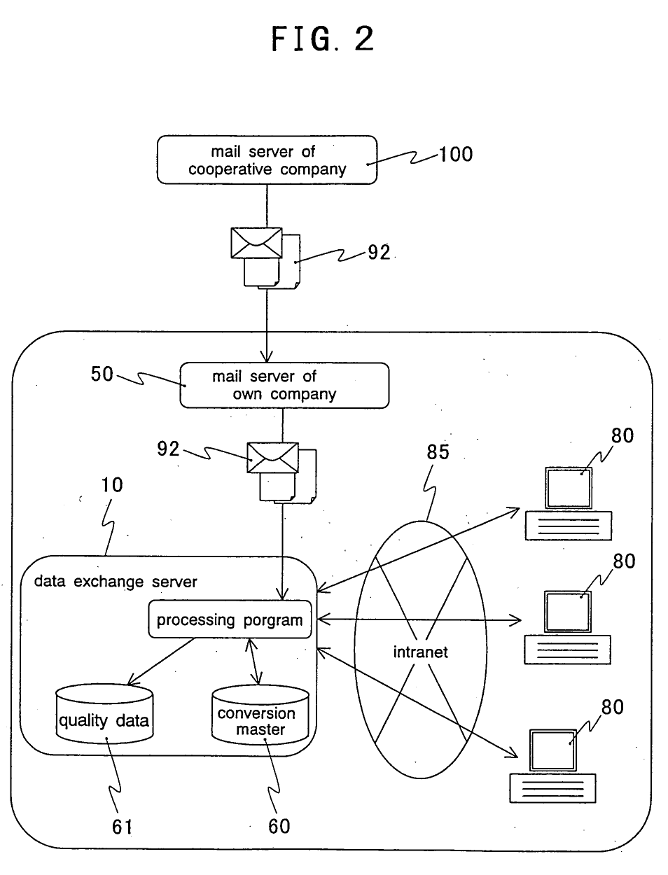

An embodiment 1 of the present invention is described with reference to FIGS. 1 and 2.

FIGS. 1 and 2 show constitutions of a data exchange system among cooperative companies according to the present invention, in which a data transmitting aspect is shown in FIG. 1 and a data receiving aspect is shown in FIG. 2. Since the system according to the present invention is based on the premise that bidirectional data is exchanged among cooperative companies, although the company on the other side is not necessarily provided with the same system constitution as that of this embodiment, it is based on the premise that at least a data transmitting and receiving function, a scheduling function and data converting/editing function which are the same as those of this embodiment are provided in the cooperative companies.

FIG. 1 shows a method and means for transmitting data by e-mail in the system according to this embodiment of the present invention. Referring to FIG. 1, a data exchange server 10 waits for data, edits a data file, makes inquiries to a quality management system 40, compresses the data file, attaches data to the mail and transmits the mail. The data exchange server 10 standardizes the items and the format of data to be exchanged among the cooperative companies, adjusts proceeding schedule of company's own production, quality control and business transaction, and data exchange schedule required by the other companies, and sets the data exchange schedule of data item-specific and the cooperative company-specific. A date table 62 is used in setting the schedule.

In addition, when the data is exchanged among the cooperative companies, it is necessary to convert ID data such as company's names, production names, production lot numbers, inspection lot numbers and overseas time lags among the other companies. Thus, correspondence between data of the others and data of one's own can be understood among the cooperative companies. A conversion master 60 is used in this data conversion.

E-mail is used in the data exchanging among the cooperative companies and the data is exchanged by being attached to the e-mail. The format of the attached data has been previously decided among the cooperative companies (CSV format, for example) so as to be mutually readable. The e-mail is transmitted to a cooperative company's mail server 100 from a mail server 50 in the company through the internet. The data transmitted by e-mail is automatically and periodically taken into a data exchange server 10 in the other company and read and processed. A fire wall is provided between the company and the internet as occasion demands. The intranet is provided in data exchange in the company as occasion demands.

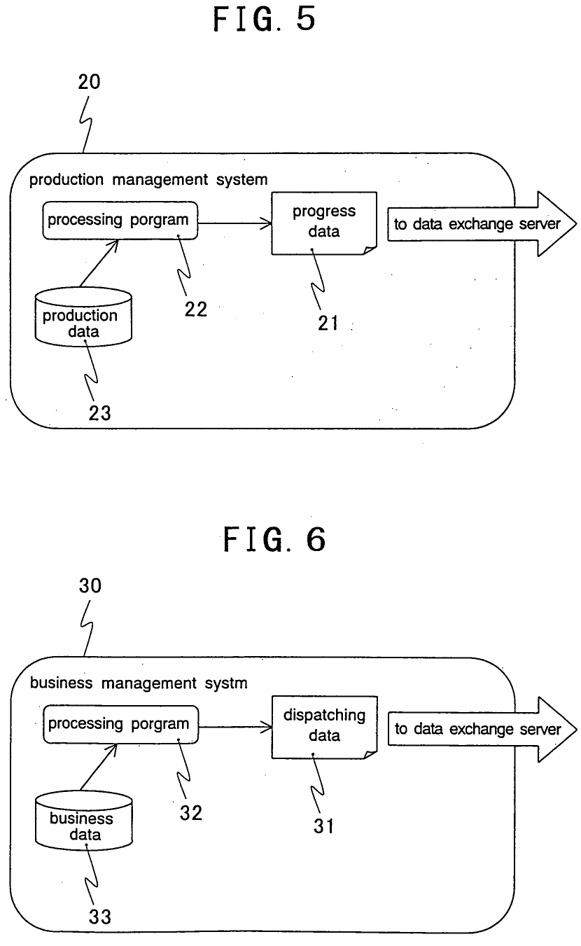

FIGS. 5, 6 and 7 show constitutions of a production management system 20, a business management system 30 and the quality management system 40, respectively. Each system reports business proceeding data of one's own company section with the schedule matched to the schedule of the data exchange server 10, and stores the data from the cooperative companies and the other section of the own company in respective databases 23, 33 and 43 and updates and maintains them.

This system is constituted by the following:
Microsoft Windows 2000
WSH (Windows Scripting Host)
Microsoft Office (Office Web Component) (Module supplied with Microsoft Office)
Microsoft MSDE (DATABASE provided from Microsoft)
   These components are one example and the system is not limited to those.

A processing program in the data exchange server 10 receives transmission time of each of data 21 and 31 sent from the production management system 20 and the business management system 30 by the scheduling functions thereof into a date table 62 in the data exchange server 10 and compares them with the date of the data taken in the past.

When the data is not new, a predetermined upper limit value is set in the number of retries and waits for the data by repeating the retry. When the retry number exceeds the upper limit value, the fact that the data files 21 and 31 have not arrived (there could be a trouble) is sent to persons in charge of the production management system and the business management system by e-mail. When the fact that the data is new is confirmed, the process is moved to the next step of data editing.

The data exchange sever 10 decides data transmission schedules for the other companies by type of data in view of schedules of the production management system 20 and the business management system 30 and the like in the company, waits for the data as described above if necessary, and transmits the data to the other companies with a periodical schedule.

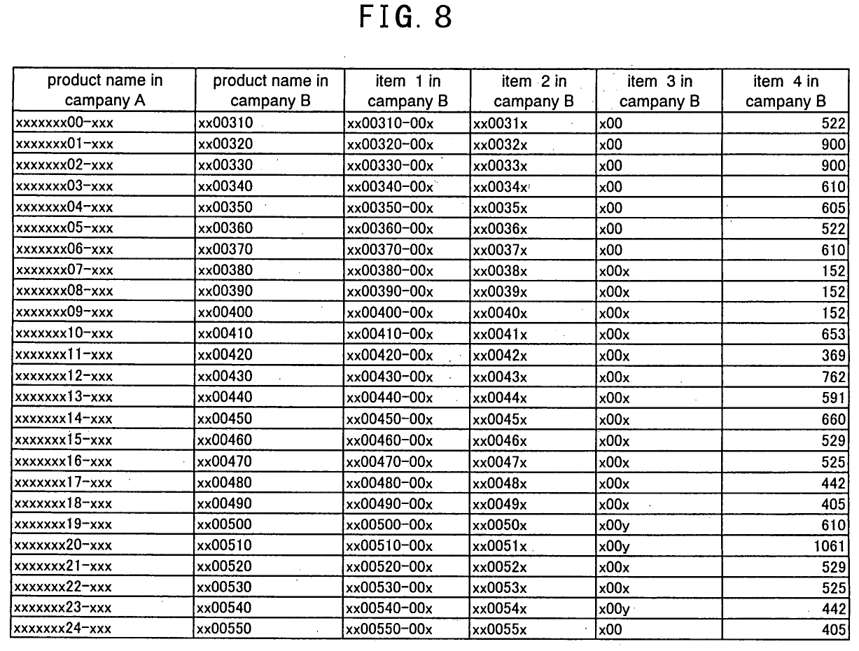

Since the specific production type names and the lot numbers in a company cannot be used in other companies, the conversion master 60 in the data exchange server is used in that case. FIG. 8 shows an example of the conversion master which converts them to the production type names and lot numbers for the other company and provides them in the file of the predetermined format such as CSV format, which has been decided among the companies.

In addition, quality information is retrieved from the quality management system 40 using the lot numbers of data sent from the production management system 20 and the business management system 30, and the retrieved result is written in the file in CSV format.

The file in CSV format is compressed with a password in view of security.

The compressed file is attached to e-mail and sent to persons in charge in the cooperative companies which have been previously registered and to a person in charge in the own company.

FIG. 2 shows a method and means for receiving data by e-mail.

A dispatched product is tested in the cooperative companies. The result of the test is output to a text-based file and compressed with a password and attached to e-mail to be transmitted to mail addresses previously registered.

A file reception program retrieves the mail stored in the mail server 50 in the company which is sent with a predetermined subject, and when there is a corresponding mail, takes the attached file into the data exchange server 10 with the body of the mail.

Then, the reception program decompresses the attached file in compressed file format with a password and adds the content of the file in which the test data is written to a quality data table in the data exchange server 10.

The file in which the test data is written is moved to a folder which can be viewed with Web browser so that it can be viewed from a terminal 80 in each section in the company connected to an intranet 85.

When an error is generated in the above processing, a mail indicating that is sent to a person in charge of browsing. Thus, the stored test data can be browsed from the terminal 80 in each section in the company connected to the intranet 85.

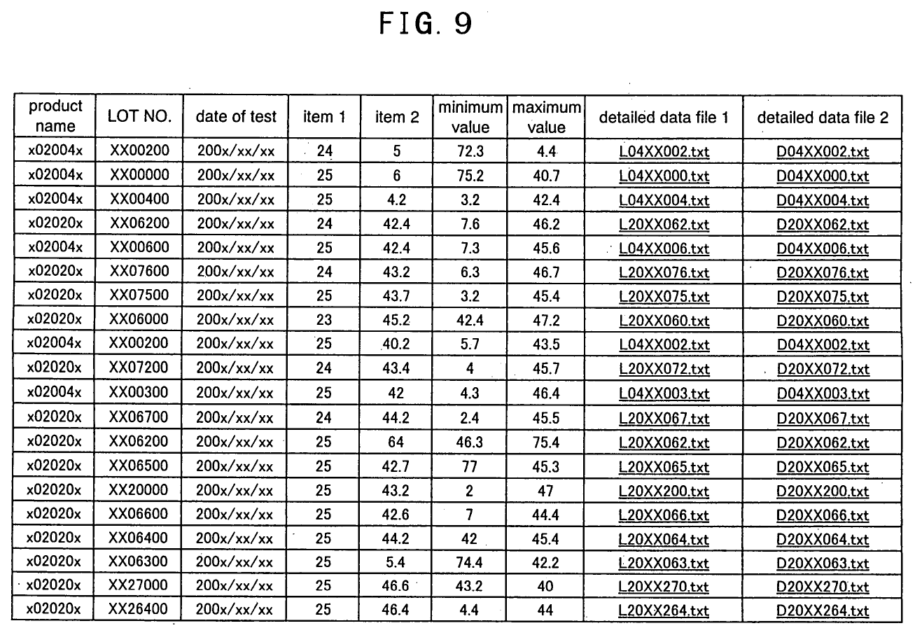

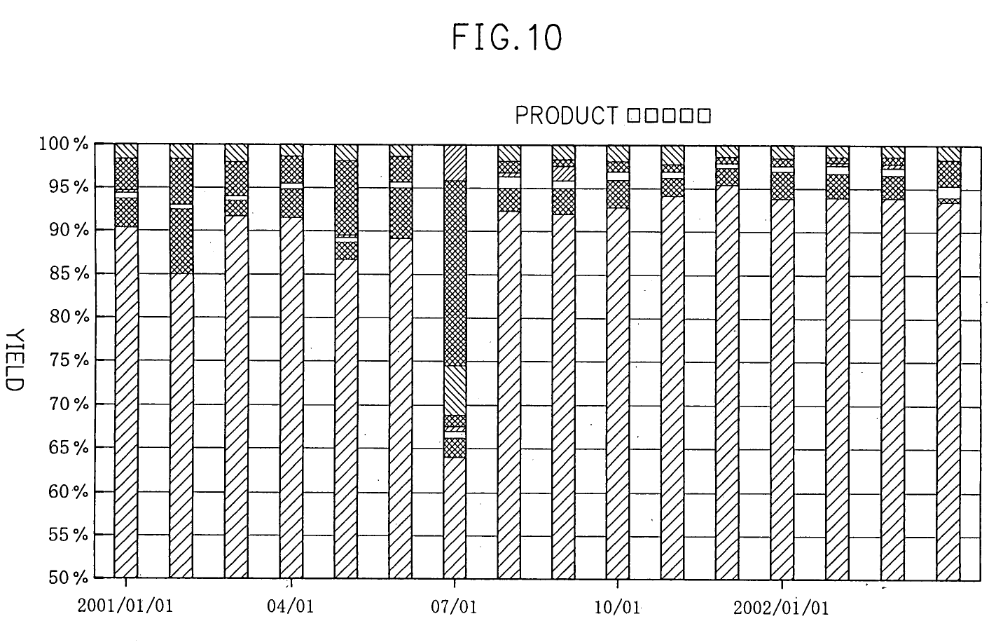

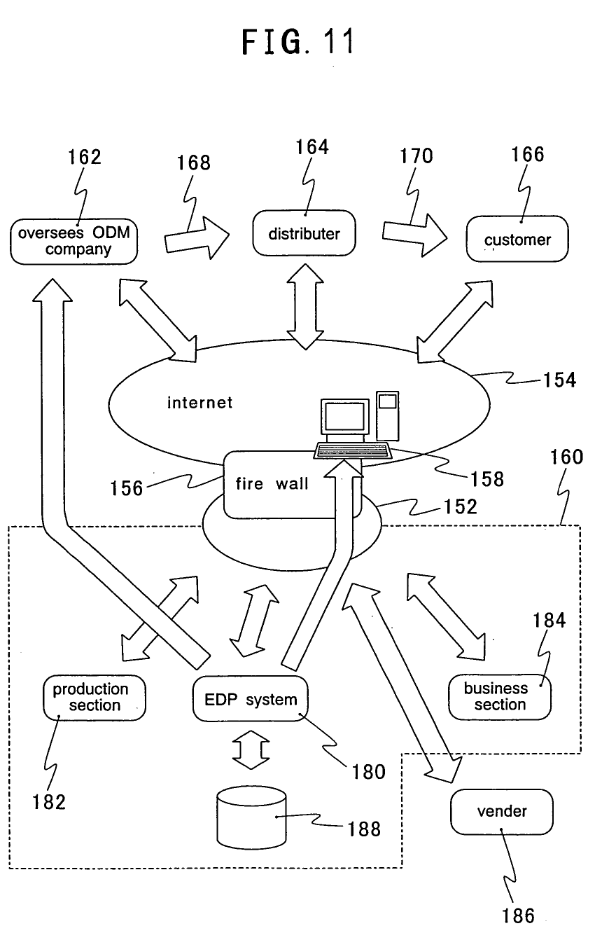

The test data can be viewed in a table form (FIG. 9) or a graph form (FIG. 10) by setting a search condition and searching for the test data.

### EMBODIMENT 2

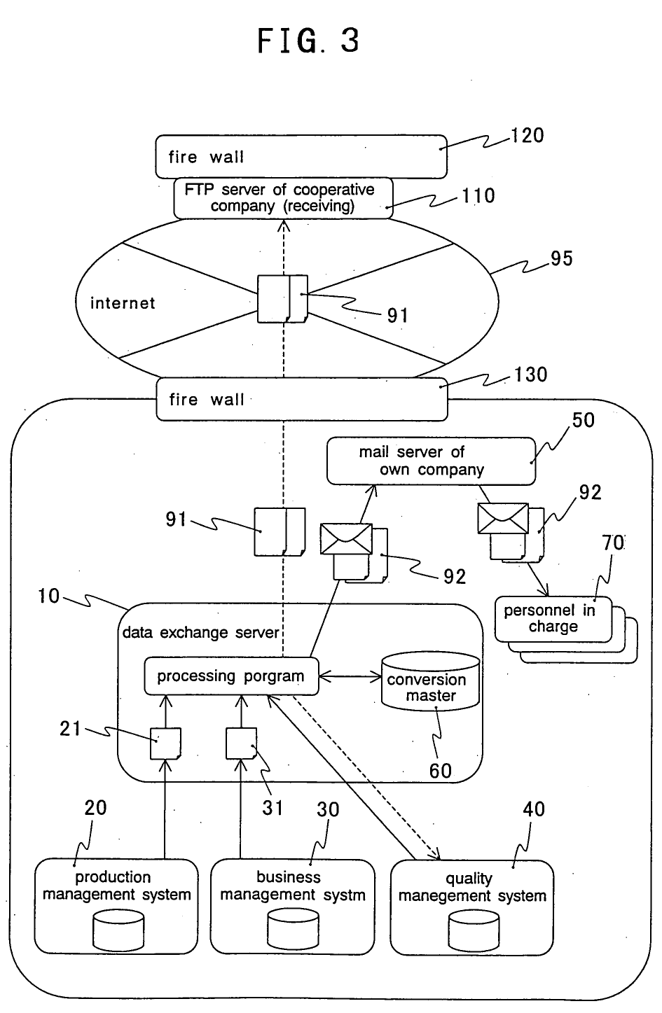

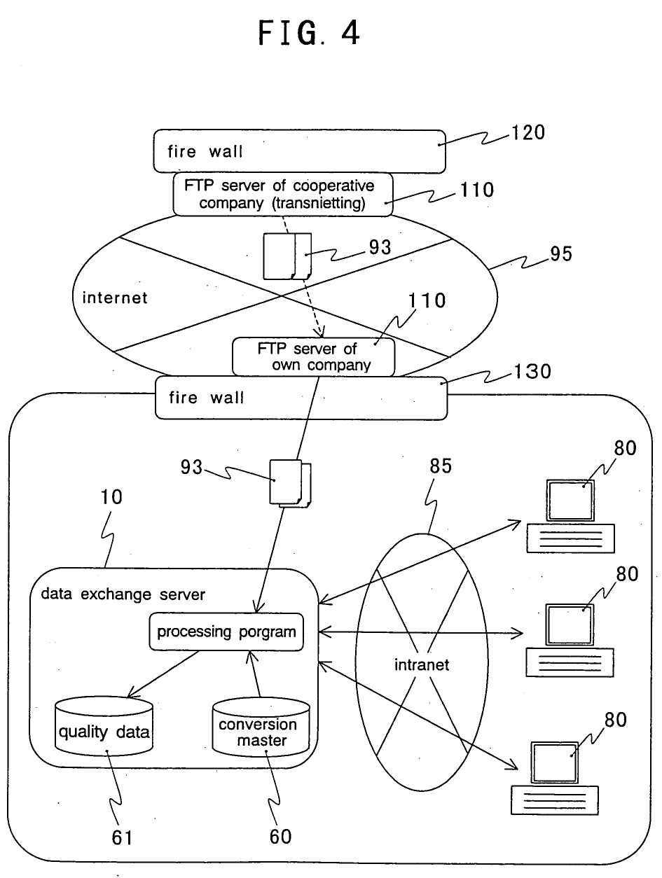

An embodiment 2 of the present invention is described with reference to FIGS. 3 and 4.

This embodiment shows a method and means for transmitting and receiving data using FTP in the data exchange system among cooperative companies shown in the embodiment 1. In addition, according to an aspect of this embodiment, it is considered that communication protocol in the company is based on HTTP and communication protocol among external cooperative companies is based on FTP. FIGS. 3 and 4 show constitutions of the system according to this embodiment using FTP in which an aspect of data transmission is shown in FIG. 3 and an aspect of data reception is shown in FIG. 4. The system including a data exchange server 10 is connected to the internet 95 through a fire wall 130 and a corresponding system in the cooperative company is connected to the internet 95 through a fire wall 120 and an FTP server 1 10.

Referring to FIG. 3, the data exchange server 10 waits for data, edits a data file, makes inquiries to a quality management system, compresses the data file, and performs FTP transmission.

This system is constituted by the following:
Microsoft Windows 2000
WSH (Windows Scripting Host)
Microsoft Office (Office Web Component) (Module supplied by Microsoft Office)
Microsoft MSDE (free DATABASE provided from Microsoft)
Curl (software name of free use, which implements FTP transmission function on the base of HTTP)
   These components are one example and the system is not limited to those.

A transmission program in the data exchange server 10 receives transmission time information of each of data 21 and 31 sent from the production management system 20 and the business management system 30, respectively by the schedule functions thereof, into a data check table (data table 62) in the data exchange server and compares them with the date of data taken in the past.

When the data is not new, a predetermined upper limit value is set in the number of retries and repeats the retry. When the number of retries exceeds the upper limit value, the fact that the data files 21 and 31 have not arrived (there could be a trouble) is sent to persons in charge of the production management system and the business management system by e-mail.

When the fact that the data is new is confirmed, the process is moved to the next step of data editing.

Since the specific production type names and the lot numbers in a company cannot be used in the other companies, the conversion master 60 (FIG. 8) in the data exchange server is used, to convert them to the production type names and lot numbers for the other company and provides them in the file of the format such as CSV format, for example.

In addition, quality information is retrieved from a quality management system 40 using the lot numbers of data sent from the production management system 20 and the business management system 30, and the retrieved result is written in the file in CSV format. The file in CSV format is compressed with a password in view of security.

The compressed file with the password is transmitted to the FTP server 110 of a designated cooperative company outside of the fire wall 130, using a proxy server which can pass through the fire wall. As the proxy server, a proxy server software such as Curl can be used.

Normally, in order to perform transmission to the FTP server outside of the fire wall 130, it is necessary to set an FTP server for transmission. However, when this method (proxy server) is used, the transmission can be performed to the FTP server outside of the fire wall 130 without setting the FTP server for transmission.

FIG. 4 shows a method and means for receiving data using FTP.

A dispatched product is tested in the cooperative companies. The result of the test is output to a text-based file and compressed with a password and transmitted to the FTP server 140 in the (own) company.

A file reception program which is periodically carried out is sent with a predetermined subject, retrieves the file stored in the FTP server 140 and when there is a corresponding file, takes the file into the data exchange server.

Then, the reception program decompresses the attached file in compressed file format with the password and adds the content of the file in which the test data is written to a quality data table in the data exchange server 10.

The file in which the test data is written is moved to a folder which can be viewed with Web browser so that it can be viewed from a terminal 80 in each section in the company connected to an intranet 85.

When an error is generated in the above processing, a mail indicating that is sent to a person in charge of browsing. Thus, the stored test data can be browsed from the terminal 80 in each section in the company connected to the intranet 85.

The test data can be viewed in a table form (FIG. 9) or a graph form (FIG. 10) by setting a search condition and searching for the test data.

As described above, according to the present invention, information required from the cooperative company such as the progress condition, a dispatching condition and quality information of the product to the cooperative companies can be periodically provided. In addition, since the test result can be obtained from the cooperative companies, a yield of a future product can be improved. That is, data can be extracted among the cooperative companies bidirectionally. In addition, since a general-purpose server or a free use software is used, the system can be constituted at low cost.

### INDUSTRIAL APPLICABILITY

There is provided a data exchange system among cooperative companies, which standardizes information items among companies in which information is exchanged, and extracts and determines the information item to be transmitted or received, so that information such as the progress condition, a dispatching condition and quality information of a product, which cooperative companies requires can be periodically provided.

1. A data exchange system in which data is mutually exchanged among a plurality of cooperative companies which produce products cooperatively, comprising periodically collecting or retrieving at least one of product progress information, quality information, and business information of one's own company, standardizing and editing the data for transmission to cooperative companies, exchanging the data between one's own company and another of the cooperative companies, outputting transmission data to a file in a fixed format as attached data of e-mail, automatically and periodically transmitting the e-mail to the cooperative companies, and receiving e-mail corresponding to the transmission data from the cooperative companies.

2. The data exchange system according to claim 1, including using FTP as a communication protocol of the data exchange.

3. The data exchange system according to claim 2, including using a software proxy server as an FTP function for transmission.

4. The data exchange system according to claim 1, wherein, upon collecting or retrieving data required for creating transmission, when the collected or retrieved data is not new, retrying a fixed number of times to wait for data and when new data is not obtained within the fixed number of times, sending an e-mail, indicating that new data has not obtained, to an address of a person who supplied the data.

5. The data exchange system according to claim 1, including a database which receives data collected in one's own company and received from the cooperative companies in a fixed cycle and stores, updates, and maintains the data.

6. The data exchange system according to claim 5, including disclosing the data in the database in one's own company through an intranet.

7. The data exchange system according to claim 1, including a conversion master for converting data between one's own company and one of the cooperative companies, including product names and lot numbers, used in each of the cooperative companies.

8. The data exchange system according to claim 1, including adding to the file attached to said e-mail a password and compressing the file.
